(19) United States
(12) Patent Application Publication
(10) Pub. No.: US 2019/0333212 A1
(43) Pub. Date: Oct. 31, 2019

(54) VISUAL CARDIOMYOCYTE ANALYSIS

(71) Applicants: TAMPEREEN YLIOPISTO, Tampereen Yliopisto (FI); TTY-SÄÄTIÖ, Tampere (FI)

(72) Inventors: Ville MUHONEN, Tampere (FI); Antti AHOLA, Tammpere (FI); Jari HYTTINEN, Tampere (FI)

(73) Assignees: Tampereen Yliopisto, Tampereen Yliopisto (FI); TTY-säätiö, Tampere (FI)

(21) Appl. No.: 16/312,598

(22) PCT Filed: Jun. 20, 2017
(86) PCT No.: PCT/FI2017/050473

§ 371 Date: Dec. 21, 2018

(30) Foreign Application Priority Data
Jun. 23, 2016 (FI) 20165520

(51) Int. Cl. G06T 7/00; G06K 9/00; G06K 9/46; G06K 9/48; G06T 7/60

(52) U.S. Cl. CPC G06T 7/0012; G06K 9/00127; G06K 9/4633; G06T 2207/30024; G06T 7/60; G06T 2207/10056; G06K 9/48

(57) ABSTRACT

Disclosed is a technique for estimating a biomechanical structure of one or more derived human cardiomyocytes (CMs) on basis of at least one image that represents derived human CMs, the method including detecting respective image positions of predefined elements of the derived human CMs, including detecting first positions that indicate respective adhesion points of a cell outline of the derived human CMs where they attach to their substrate and detecting second positions that indicate respective positions of nuclei of the derived human CMs; dividing the image representation of the derived human CMs into a plurality of areas that represent respective sarcomeres of the derived human CMs; and carrying out a further analysis of the derived human CMs on basis of division of their image representation into the plurality of areas.

### FIELD OF THE INVENTION

The present invention relates to non-invasive analysis of one or more human cardiomyocytes (CMs). In particular, example embodiments of the present invention relate to a method, to an apparatus and to a computer program for analyzing structure of one or more human CMs.

### BACKGROUND

Genetic disorders having cardiac effects are, typically, potentially lethal without proper therapy or medication, and therefore it is of essential importance to detect signs of such a disorder early on. Moreover, cardiac side effects are a one of the most common reason for withdrawal of a drug from the market, and therefore reliably capturing any potential cardiac side effects of a drug already during the development phase would be highly beneficial.

Studying human cardiomyocytes (CMs) is a challenging task, since primary CMs taken from a living heart placed into culture dishes stop beating and start to dedifferentiate. Moreover, the procedure of extracting a test sample from a human heart in order to obtain one or more human CMs may constitute a high-risk procedure. As an alternative for using primary human CMs extracted from a living heart, human induced pluripotent stem (hiPS) cells (hiPSC) provide an interesting alternative for primary human CMs for such studies. HiPS cells can be reprogrammed from other mature cells, such as skin fibroblasts, and further differentiated into hiPSC-derived CMs that open interesting possibilities for studying human CMs in vitro.

One way to study the biomechanical properties of cultured human CMs involves usage of video microscopy, which allows for non-invasive analysis of beating characteristics of cultured human CMs, such as hiPSC-derived CMs introduced in the foregoing. An example of video-based analysis technique is described in the International patent application no. PCT/FI2013/050905, published as WO 2014/102449 A1. Video-based analysis techniques typically result in an output signal that is descriptive of contraction characteristics the human CMs under analysis, such as velocity or force of contraction.

While known video-based analysis techniques provide a useful way of non-invasive analysis of beating characteristics of hiPSC-derived human CMs, one of the challenges is selection of the cultured human CMs for use as subject of the analysis. One particular challenge in this regard lies in identifying and ensuring suitable and uniform maturity level of the cultured human CMs used in the analysis: in general, a fully mature human CM exhibits an elongated overall shape where main component of contracting motion is aligned with the main axis of the human CM of elongated shape. On the other hand, cultured human CMs that are yet not fully mature typically have a circular kind of overall shape and exhibit contracting motion from the edges of the cultured human CM towards its center.

In general, it is beneficial to apply a video-based analysis technique on one or more human CMs of desired maturity level and/or on a plurality of cultured human CMs that have uniform or substantially uniform maturity level to ensure reliable and repeatable analysis of beating characteristics. While invasive methods for estimating maturity level of cultured human CM are known in the art (such as investigating the protein expression of human CMs and determining the directions of the sarcomere structure of human CMs from immunohistochemical fluorescence imaging), these methods provide unsatisfactory results, are potentially harmful for the human CMs and also require a significant time and effort to be carried out. Therefore, there is a need for a reliable, low-complexity technique for estimating maturity level of cultured human CMs such that the human CMs under estimation are not harmed.

Moreover, another challenge in effective application of video-based analysis techniques is lack of a priori knowledge of the internal structure of the derived human CM, which would enable more efficient and/or concentrated analysis of contracting motion of derived human CMs under study.

### SUMMARY

Therefore, it is an object of the present invention to provide an analysis technique for estimating biomechanical structure of one or more cultured human CMs that is reliable and straightforward to apply while it is not harmful for the human CM it serves to analyze.

These objects of the invention are reached by a method, by an apparatus and by a computer program as defined by the respective independent claims.

According to an example embodiment, a method for estimating a biomechanical structure of one or more derived human cardiomyocytes on basis of at least one image that represents the one or more derived human cardiomyocytes is provided, the method comprising detecting respective image positions of predefined elements of the one or more derived human cardiomyocytes, comprising detecting one or more first positions that indicate respective one or more adhesion points of a cell outline of the one or more derived human cardiomyocytes where they attach to their substrate and detecting one or more second positions that indicate respective positions of one or more nuclei of the one or more derived human cardiomyocytes; dividing the image representation of the one or more derived human cardiomyocytes into a plurality of areas that represent respective sarcomeres of the one or more derived human cardiomyocytes; and carrying out a further analysis of the one or more derived human cardiomyocytes on basis of division of the image representation of the one or more derived human cardiomyocytes into said plurality of areas.

According to another example embodiment, an apparatus for estimating a biomechanical structure of one or more derived human cardiomyocytes on basis of at least one image that represents the one or more derived human cardiomyocytes is provided, the apparatus comprising a cell element detection means for detecting respective image positions of predefined elements of the one or more derived human cardiomyocytes, comprising an adhesion point detection means for detecting one or more first positions that indicate respective one or more adhesion points of a cell outline of the one or more derived human cardiomyocytes where they attach to their substrate and a nucleus detection means for detecting one or more second positions that indicate respective positions of one or more nuclei of the one or more derived human cardiomyocytes; a cell division means for dividing the image representation of the one or more derived human cardiomyocytes into a plurality of areas that represent respective sarcomeres of the one or more derived human cardiomyocytes; and a cell analysis means for carrying out a further analysis of the one or more derived human cardiomyocytes on basis of division of the image representation of the one or more derived human cardiomyocytes into said plurality of areas.

According to another example embodiment, a computer program is provided, the computer program comprising computer readable program code configured to cause performing at least a method according to the example embodiment described in the foregoing when said program code is executed on a computing apparatus.

The computer program according to an example embodiment may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for the computer program according to an example embodiment of the invention.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF THE DRAWINGS

The embodiments of the invention are illustrated by way of example, and not by way of limitation, in the figures of the accompanying drawings, where

FIG. 1a schematically illustrates a relatively immature derived human cardiomyocyte (CM);

FIG. 1b schematically illustrates a relatively mature derived human CM;

FIG. 2 illustrates a method in accordance with an example embodiment;

FIG. 3 illustrates a method in accordance with an example embodiment;

FIG. 4 illustrates a block diagram of some components of an analyzer according to an example embodiment;

FIG. 5a illustrates a block diagram of some components of an analyzer according to an example embodiment;

FIG. 5b illustrates a block diagram of some elements of some components of an analyzer according to an example embodiment;

FIG. 6 schematically illustrates an example of a cell division image derived on basis of an illustration of a single derived human CM;

FIG. 7a schematically illustrates an example of a cell division image derived on basis of an illustration of a cell aggregate of a plurality of derived human CMs;

FIG. 7b schematically illustrates an example of a cell division image derived on basis of an illustration of a cell aggregate of a plurality of derived human CMs;

FIG. 8 illustrates a block diagram of some components of an apparatus for implementing an analyser according to an example embodiment;

FIG. 9 illustrates image segmentation according to an example;

FIG. 10 illustrates image segmentation according to an example;

FIG. 11 illustrates image segmentation according to an example;

FIG. 12 illustrates adhesion point detection according to an example;

FIG. 13 illustrates adhesion point detection according to an example;

FIG. 14 illustrates adhesion point detection according to an example; and

FIG. 15 illustrates definition of first and second connecting lines according to an example.

### DETAILED DESCRIPTION OF SOME EMBODIMENTS

Along the lines discussed in the foregoing, recently developed techniques to reprogram human cells provide interesting possibilities to study differentiated human cells, which have not been available before due to too risky procedure or due to rapid dedifferentiation of the primary cells in culture. Such techniques provide, for example, interesting possibilities to study human cells of several types, for example human CMs, on basis of visual data depicting one or more human cells, where the visual data may comprise an image, a plurality of images and/or a video stream.

HiPSC-derived human CMs described in the foregoing constitute an example of cultured or otherwise derived human cells. HiPS cells can be obtained from any individual, also from those carrying certain genotype, by reprogramming already differentiated adult cells, such as skin fibroblasts, into a pluripotent state. Such hiPS cells can then be differentiated into the cell type of interest and with disease and genotype specific hiPS cells to obtain differentiated cells, for example to CMs that carry the disease causing phenotype. In this regard, it has been shown that the genotype and phenotype of the cells so derived is similar to that of the actual cells of the individual, e.g. the hiPSC-derived human CMs may carry the same mutation as the CMs in the heart of the individual, see e.g. Lahti A. L., V. J. Kujala, H. Chapman, A. P. Koivisto, M. Pekkanen-Mattila, E. Kerkelä, J. Hyttinen, K. Kontula, H. Swan, B. R. Conklin, S. Yamanaka, O. Silvennoinen, and K. Aalto-Setälä, Model for long QT syndrome type 2 using human iPS cells demonstrates arrhythmogenic characteristics in cell culture, Dis. Model. Mech. 5:220-230, 2012.

As another example, differentiated cells can also be obtained by so called direct differentiation method. This method enables the induction of differentiated cells, e.g. human CMs, directly from another differentiated cell type, e.g. from fibroblast, thus bypassing the stem cell state applied in the hiPSC approach outlined in the foregoing.

In the following, the term derived human CM is used to refer to a human CM derived from a human cell different from a CM, e.g. by using the hiPSC method, the direct differentiation method or another suitable method known in the art. The cell of other type used as basis for deriving the human CM may be referred to in the following as a source cell. Non-limiting examples of suitable types of source cells that are relatively straightforward to obtain include dermal fibroblasts or keratinocytes, blood cells such as leucocytes, mucosal cells and endothelial cells. Derived human CMs provide interesting possibilities for non-invasive study of individual CMs to enable analysis of its beating behavior and, in particular, any deviations from beating behavior of a healthy human CM. Consequently, results of such analysis are potentially useable, for example, in detection of genetic disorders having a cardiac effect and/or in detection of cardiac side effects of a drug during development or testing of the drug.

In the following, various examples concerning a technique for estimating biomechanical structure of one or more derived human CMs on basis of visual data are described. Results of such an estimation procedure are useable, for example, for selection of suitable derived human CMs of certain maturity level for further analysis and/or guiding further analysis (e.g. motion analysis) in accordance with the estimated biomechanical structure of the one or more derived human CMs. The further analysis may involve a non-invasive analysis or an invasive analysis. As a non-limiting example, a non-invasive further analysis that bases on a sequence of images (e.g. a video sequence) depicting one or more derived human CMs selected for the further analysis may be carried out. Moreover, as a non-limiting example, the non-invasive analysis may be carried out as described in WO 2014/102449 A1, which is included by reference in its entirety herein. However, the procedure(s) applied as the further analysis of the selected derived human CM(s) and/or details thereof are outside the scope of the present invention.

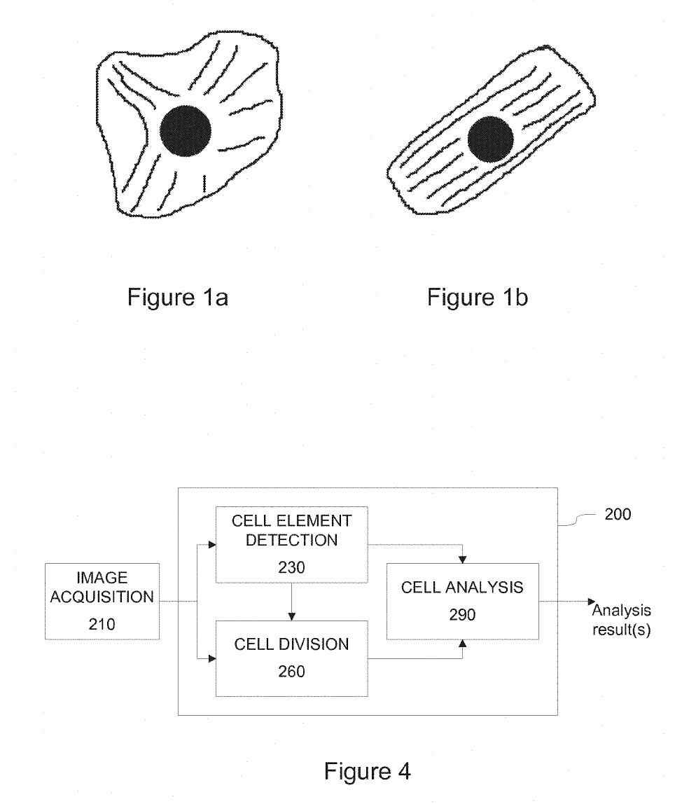

As described in the foregoing, the, the overall shape of the derived human CM serves as an approximate indication of its maturity level. However, a more accurate estimation of the maturity level can be obtained via knowledge of sarcomere orientation of the derived human CM. As illustrative examples in this regard, FIG. 1a schematically illustrates a relatively immature derived human CM and FIG. 1b schematically illustrates a relatively mature derived human0 CM. Both these illustrations show an outline of the derived human CM that encloses a black dot that represents the nucleus of the derived human CM and a plurality of lines that represent orientation of respective plurality of sarcomeres in the derived human CM. In the relatively immature derived human CM of FIG. 1a the overall shape of the derived human CM is reminiscent of a square or a circle, while the sarcomeres are predominantly oriented from the edges of the derived human CM towards the nucleus. In contrast, in the relatively mature derived human CM of FIG. 1b the overall shape of the derived human CM approaches an elongated rectangle or ellipse with its sarcomeres predominantly oriented in direction of the longitudinal axis of the derived human CM.

Throughout the description, reference is made to visual analysis of a derived human CM in singular, while the analysis techniques described herein readily generalize into visual analysis of a plurality of derived human CMs. Moreover, even though visual analysis of derived human CMs constitute an interesting framework for application of the analysis technique described herein and the subject of the analysis is predominantly referred to as derived human CM, the visual analysis technique described herein is equally applicable to primary human CMs or CMs of other origin as well.

The derived human CM under analysis may be a dissociated derived human CM, i.e. a single derived human CM that is not attached to any other human CM and that is depicted in the visual data in isolation from other human CMs. In another example, the derived human CM under analysis may be a single derived human CM that is part of a cluster of derived human CMs. In a further example, the subject of analysis includes a plurality of derived human CMs that constitute a cluster of derived human CMs (or a part of such cluster).

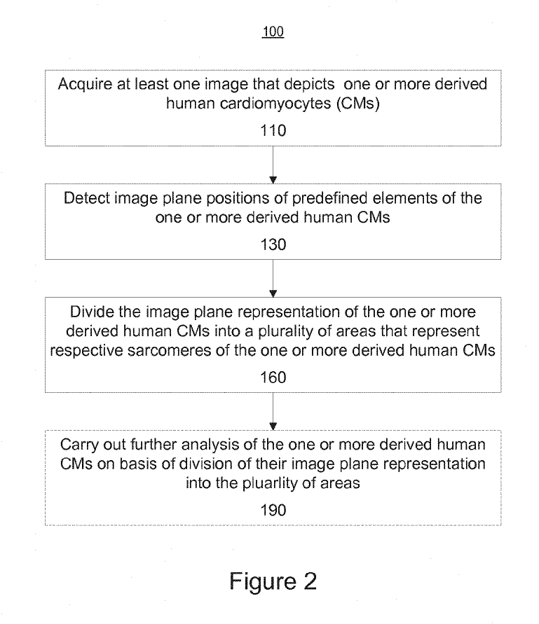

FIG. 2 depicts a flow chart that outlines a method 100 for estimating a biomechanical structure of a derived human CM based on visual data that depicts the derived human CM. The method 100 attempts to divide a human CM depicted by visual data, e.g. an image, into segments that represent sarcomeres of the depicted human CM. The method 100 commences by acquiring an image that depicts a derived human CM, as indicated in block 110, followed by detecting image plane positions of one or more predefined elements of the derived human CM depicted in the acquired image, as indicated in block 130, and dividing the image plane representation of the derived human CM, on basis of the detected positions of one or more elements of the derived human CM, into one or more areas that represent respective positions of one or more sarcomeres of the derived human CM, as indicated in block 160. The method 100 may further proceed to carrying out a further analysis of the derived human CM on basis of its division into said one or more areas, as indicated in block 190.

In an example, the further analysis associated with block 190 comprises estimating maturity level of the derived human CM depicted in the acquired image on basis of its division into said one or more areas. In such an example the method 100 may be considered as a method for estimating maturity level of the derived human CM depicted in the acquired mage. In another example, the further analysis of block 190 comprises motion estimation within one or more sarcomeres of the derived human CM in accordance with positions of the respective sarcomeres e.g. in a video stream depicting the same derived human CM in the same position of the image plane as in the acquired image used as basis for determination of the biomechanical structure.

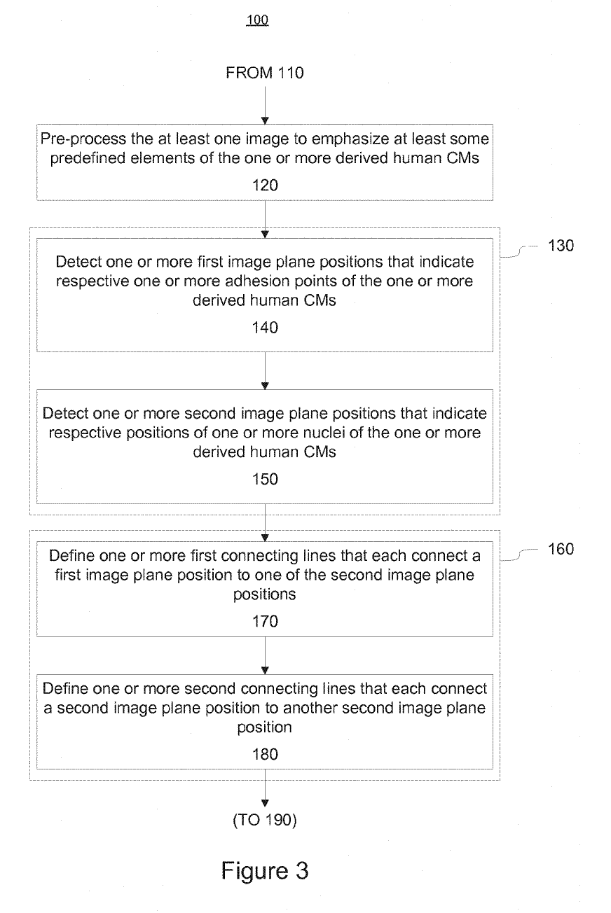

FIG. 3 depicts a flow chart outlines the method with additional detail with respect to operations of blocks 110, 130 and 160. The operations of block 110 may be followed by pre-processing the acquired image to emphasize some elements of the derived human CM depicted in the acquired image, as indicated in block 120. The operations of block 130 may include detecting one or more first image plane positions that indicate respective one or more adhesion points of the derived human CM depicted in the acquired image (i.e. points at which the depicted derived human CM attaches to its substrate), as indicated in block 140, and detecting one or more second image plane positions that indicate respective positions of one or nuclei of the derived human CM depicted in the acquired image, as indicated in block 150.

The operations of block 160 may include defining one or more first connecting lines, where each first connecting line connects a first image plane position to a second image plane position, as indicated in block 170, and defining one or more second connecting lines, where each second connecting line connects a second image plane position to another second image plane position, as indicated in block 180.

FIG. 4 illustrates a block diagram of some (logical) components of an analyzer 200 for estimating a biomechanical structure of a derived human CM based on visual data that depicts the derived human CM. The analyzer 200 is further depicted with an image acquisition means 210 for acquiring at least one image depicting the derived human CM. Although depicted in the example of FIG. 4 as entity separate from the analyzer (e.g. as an entity of a device communicatively coupled to a device providing the analyzer 200), in other examples the image acquisition means 210 or part thereof may be provided as part of the analyzer 200. The analyzer 200 comprises a cell element detection means 230 for detecting image plane positions of one or more predefined elements of the derived human CM depicted in the acquired image, a cell division means 260 for dividing the image plane representation of the derived human CM, on basis of the detected positions of one or more elements of the derived human CM, into one or more areas that represent respective positions of one or more sarcomeres of the derived human CM, and a cell analysis means 290 for carrying out a further analysis of the derived human CM on basis of its division into said one or more areas.

In an example, the cell analysis means 290 comprises maturity level estimation means for estimating the maturity level of the derived human CM depicted in the acquired image on basis of its division into said one or more areas. In another example, the cell analysis means 290 comprises motion estimation means for analyzing contracting motion within one or more sarcomeres of the derived human CM in accordance with positions of the respective sarcomeres e.g. in a video stream depicting the same derived human CM in the same position of the image plane as in the acquired image used as basis for determination of the biomechanical structure.

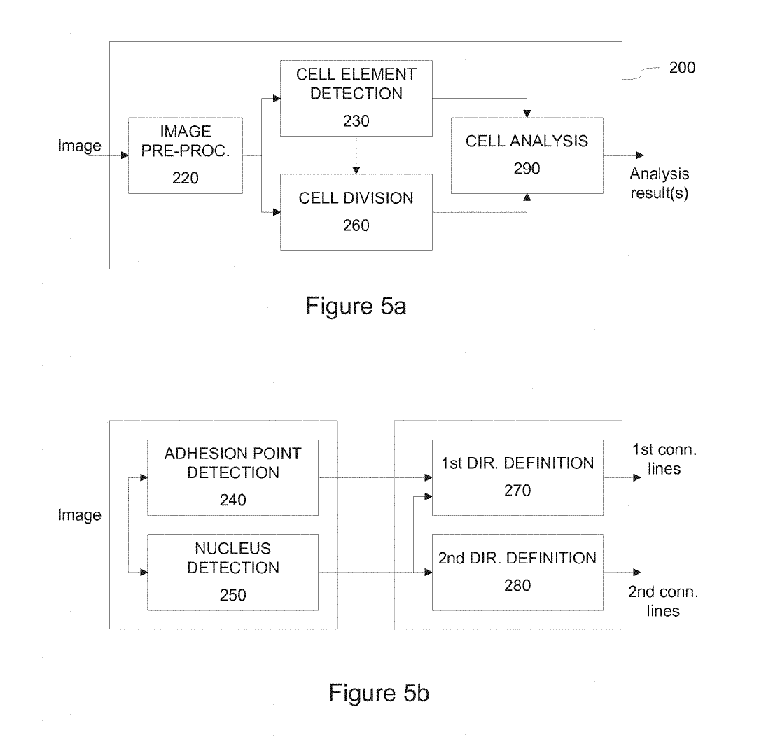

As indicated in FIG. 5a, the analyzer 200 may further comprise image pre-processing means 220 for pre-processing the acquired image to emphasize some elements of the derived human CM depicted in the acquired image.

As indicated in FIG. 5b, the cell element detection means 230 may comprise an adhesion point detection means 240 for detecting one or more first image plane positions that indicate respective one or more adhesion points of the derived human CM depicted in the acquired image, and nucleus detection means 250 for detecting one or more second image plane positions that indicate respective positions of one or more nuclei of the derived human CM depicted in the acquired image. As further indicated in FIG. 5b, the cell division means 260 may comprise a first direction detection means 270 for defining one or more first connecting lines, where each first connecting line connects a first image plane position to a second image plane position, and a second direction detection means 280 for defining one or more second connecting lines, where each second connecting line connects a second image plane position to another second image plane position.

The steps of the method 100 and (logical) components of the analyzer 200 outlined in the foregoing are described in more detail via various examples in the following.

Referring to block 110 of the method 100, the operations associated therewith may be carried out by the image acquisition means 210. Hence, the operations described herein as examples of characteristics of the image acquisition means 210 are equally applicable as method steps associated with block 110 of the method 100.

In an example, the image acquisition means 210 comprises image capturing means for capturing the image that depicts the derived human CM under analysis by the analyzer 200. As a non-limiting example in this regard, the image acquisition means 210 may comprise an imaging arrangement that includes a microscope of sufficient resolution having a digital camera or a digital camera module integrated therein. Alternatively, the imaging arrangement may comprise a dedicated microscope providing sufficient resolution and a digital camera or a digital camera module mounted thereon to capture the sequence of images through the microscope. The digital camera (module) may include a digital video camera (module) or digital still camera (module). The image(s) captured using the image acquisition means 210 may be stored in a suitable storage medium, e.g. in a disk drive or in a storage apparatus of other suitable type for subsequent analysis by the analyser 200 or the image(s) may be passed directly for analysis by the analyser 200.

In another example, the image acquisition means 210 just provides an interface for acquiring a pre-captured image that depicts the derived human CM of interest. In this regard, one or more images depicting the derived human CM of interest may be stored in a storage medium, e.g. in a disk drive or in a storage apparatus of other suitable type, accessible by the image acquisition means 210, and the image depicting the derived human CM may be read from the storage medium and passed for analysis by the analyser 200.

Various types of images and imaging arrangements may be employed in context the method 100 and/or the analyser 200. In a non-limiting example, the image that depicts the derived human CM is provided as a monochrome image, e.g. as a greyscale image. Pixels of the image may be represented e.g. 8-bit values, hence providing 2⁸=256 different levels of brightness. The resolution of the image as number of pixels may be selected e.g. such that the portion of captured images depicting the derived human CM of interest is at least 100×100 pixels, preferably around 150×150 pixels or more to provide a sufficient image resolution enabling accurate enough analysis of structural elements of the depicted derived human CM. While a different (e.g. higher) number of bits per pixel and a different (e.g. higher) image resolution may be employed, the exemplifying number of bits per pixel and exemplifying image resolution referred to hereinbefore provide a sufficient image quality that enables the analysis at sufficient accuracy and reliability without using excessive amount of storage capacity for storing such images. In particular, in examples where a single (still) image is used as basis of the biomechanical structure estimation, images of high(er) number of bits per pixel and/or high(er) image resolution in comparison to the approximate minimum requirements outlined in the foregoing are typically preferred. The image may be directly captured as an image of desired characteristics, e.g. as a monochrome image with desired number of bits per pixel and/or at desired image resolution according the exemplifying image characteristics provided in the foregoing. Alternatively, the image may be captured in higher quality, e.g. in full colour, with higher number of bits per pixel and/or at higher image resolution and subsequently, i.e. before the analysis, converted into images of desired characteristics. While such avoidance of ‘overprovisioning’ of the image quality facilitates keeping the required storage capacity reasonable, it also serves to keep the computational complexity of the analysis lower.

The examples of image characteristics described in the foregoing implicitly assume usage of a two-dimensional (2D) image. In other examples, the image depicting the derived human CM under analysis may comprise a three-dimensional (3D) image or a (2D) image derived on basis of a 3D image. In this regard, non-limiting examples of 3D images include tomographic images and selective/single plane illumination microscopy (SPIM) images. Although the following description predominantly, at least implicitly, suggests analysis and processing of a 2D image that depicts the derived human CM under analysis, the description readily generalizes into processing of (at least a segment of) a 3D image or a 2D image derived on basis or extracted from a 3D image.

Referring to the image pre-processing means 220 that may be provided as part of the image acquisition means 210, the exemplifying operations associated with the image pre-processing means 220 described in the following are equally applicable as method steps associated with the block 120 of the method 100. The image pre-processing carried out by the image pre-processing means 220 may also be referred to as image segmentation (and hence the image pre-processing means may be, alternatively, referred to as image segmentation means). The image pre-processing means 220, if applied, serves to process the acquired image into a preprocessed image (or a segmented image) that is useable as basis for processing by the cell element detection means 230 (and possibly also the image division means 280) instead of the acquired image as such.

The image pre-processing, or segmentation, is carried out in order to emphasize visual appearance of desired predefined elements of the derived human CM depicted in the acquired image. Examples of the predefined cell elements to be emphasized in the pre-processing include an outline of the derived human CM depicted in the acquired image and/or nuclei of the derived human CM depicted in the acquired image. Various pre-processing methods serving this purpose are known in the art. As a non-limiting example in this regard, the numbered clause 1 of the Appendix of this description describes an example of segmentation procedure that may be applied as the pre-processing procedure in the image pre-processing means 220. Hence, in the pre-processed (or segmented) image, at least the cell elements of interest are visually emphasized to ensure efficient and reliable detection of cell elements of interest in the pre-processed image by operation of the cell element detection means 230.

Referring to block 130 of the method 100, the operations associated therewith may be carried out by the cell element detection means 230. Hence, the operations described herein as exemplifying characteristics of the cell element detection means 230 are equally applicable as method steps associated with block 130 of the method 100.

The cell element detection means 230 is provided for detecting image plane position of one or more predefined elements of the derived human CM depicted in the acquired image, which positions are useable in subsequent estimation of positions of sarcomeres of the depicted derived human CM (cf. block 160 of the method 100 and the cell division means 260). In an example illustrated in FIG. 5b, the cell element detection means 230 comprises the adhesion point detection means 240 and the nucleus detection means 250 outlined in the foregoing. In this regard, the exemplifying operations associated with the adhesion point detection means 240 described in the following are equally applicable as method steps associated with the block 140 of the method 100, whereas the exemplifying operations associated with the nucleus detection means 250 described in the following are equally applicable as method steps associated with the block 150 of the method 100.

The adhesion point detection means 240 may be arranged to detect location of an outline of the derived human CM depicted in the acquired image. Alternatively, the adhesion point detection means 240 may receive information that defines the outline of the derived human CM from another entity, e.g. from the image pre-processing means 220. The outline may be defined, for example, as a set of image plane positions that represent location of the outline of the derived human CM cell in the image plane. Herein, we done this set of image plane positions as set Sₒₗ. The outline of the derived human CM may also be referred to as cell outline, as cell perimeter or as cell border. As an example, an edge detection technique or a region-based technique known in the art, such as the Canny method, may be employed in detecting the cell outline in the image plane. Further details and examples of other techniques for cell outline detection are described e.g. in Solomon C, Breckon T, “Fundamentals of Digital Image Processing: A Practical Approach Using Matlab”, John Wiley & Sons Inc., 2011.

The image plane positions in the set Sₒₗ, conceptually, provide a ‘sampled’ version of the continuous cell outline depicted in the acquired image. The set Sₒₗ may be provided e.g. as an ordered list of image plane positions where the image plane positions that define the cell outline are arranged in a clockwise or a counter-clockwise order. Each image plane position may be defined as a point in a Cartesian coordinate system having its origin in predefined location of the image plane (e.g. in a center of the acquired image or in one of the corners of the acquired image).

As described in the foregoing, the adhesion point detection means 240 may be arranged to define one or more image plane positions that represent respective adhesion points of the depicted derived human CM located at or close to the cell outline. Herein, we refer to these image plane positions as first positions p₁(k), with k=1, . . . , K, where K is an integer with K>0. As a particular example, the adhesion point detection means 240 may be arranged to define the first positions p₁(k) as one or more positions of the outline of the cell. In this regard, the adhesion point detection means 240 may analyze the image plane positions of the set Sₒₗ that represent the cell outline in order to detect one or more local maxima of curvature of the cell outline and determine at least some of the detected one or more local maxima of curvature to represent the first positions p₁(k). The first positions p₁(k) may also be referred to as corner points of the derived human CM. The first positions p₁(k) so determined are assumed represent the locations of the derived human CM where tension of the cell outline is at its highest and where at least some of the adhesive structures of the derived human CM are hence located (further discussion regarding this aspect is found e.g. in the numbered clause 2 of the Appendix of this description).

It should be noted that the adhesion points of the depicted derived human CM represented by the first positions p₁(k), a.k.a. the corner points, typically only represent part of the adhesion points of the derived human CM: there may be one or more additional adhesion points along the cell outline and/or in other parts of the depicted derived human CM. The adhesion points represented by the first positions p₁(k) are, however, the ones of interest for subsequent operation of the cell division means 260.

In general, any technique known in the art may be employed in detecting the image plane positions that represent local maxima of curvature of the cell outline. As a non-limiting example in this regard, the adhesion point detection means 240 may divide the image plane positions in the set Sₒₗ into non-overlapping subsets sₚ such that each subset sₚ includes J adjacent image plane positions of the set Sₒₗ (where J is an integer larger than one), derive a respective normal for each subset sₚ, determine respective angles between adjacent normals so derived, and identify one or more local maxima of the angle between two adjacent normals as a position of the local maxima of the curvature of the cell outline. In a variation of the above example, the step of determining the angles between adjacent normals is followed by detecting one or more contiguous sub-sets of angles between adjacent normals where the angle exceeds a predefined threshold and identifying, for each sub-set so detected, a mid-point of the subset as the respective local maxima of the curvature of the cell outline. In a further variation, either of the above examples may commence by determining a respective tangent for each subset sₚ of adjacent image plane positions in the set Sₒₗ instead of deriving the respective normal and performing the subsequent steps on basis of the tangents instead of the normals. In a further example, first positions p₁(k), or the corner points, may be identified by using a procedure outlined in the numbered clause 3 of the Appendix of this description.

The adhesion point detection means 240 may be arranged to identify those local maxima of the curvature of the cell outline where the curvature exceeds a predefined threshold as the first positions p₁(k). Moreover, the adhesion point detection means 240 may consider only those local maxima of the curvature of the cell outline that represent outward-extending segment of the cell outline and, in contrast, ignore those local maxima of the curvature of the cell outline that represent inward-extending segment of the cell outline. Herein, the expression outward-extending segment of the cell outline refers to a segment that extends away from the center of the derived human CM while the expression inward-extending segment refers to a segment that extends towards the center of the cell, where the center may comprise, for example, the center of mass computed on basis of the image plane positions that are enclosed by the cell outline.

In general, the nuclei of the derived human CM cells are typically identifiable in the acquired image as circular or substantially circular shapes. In a typical case, a circular or substantially circular shape that represents the nucleus in the acquired image appears slightly brighter image portion than its immediate surroundings within the outline of the cell, while in a few cases the circular or substantially circular shape that represents the nucleus may appear as a slightly darker image portion than its immediate surroundings. Typically, approximately at or close to the center of the nucleus, there can be seen the nucleolus as a small circle or dot of darker appearance, that is to say, as a portion of the nucleus that is darker than other parts of the nucleus.

The nucleus detection means 250 may be arranged to detect location of one or more nuclei in the image plane within the cell outline defined by image plane positions in the set Sₒₗ. In this regard, the nucleus detection means 250 may employ any technique known in the art that is suitable for detecting circular or substantially circular shapes. As a non-limiting example in this regard, the nucleus detection means 250 may employ the Circular Hough Transform (CHT) known in the art for this purpose, which is described in more detail e.g. in Yuen H K, Princen J, Illingworth J, Kittler J, “A Comparative study of Hough transform methods for circle finding”, Proc. 5th Alvey Vision Conf., 1989, whereas e.g. Matlab function ‘Imfindcircles’ (available at the filing date of the present patent application at http://se.mathworks.com/help/images/ref/imfindcircles.html) may be applied to implement the CHT. The CHT or a corresponding technique may be applied in order to identify circular or substantially circular shapes that appear darker than their (immediate) surroundings and/or to identify circular or substantially circular shapes that appear brighter than their (immediate) surroundings. In an example, a circular or substantially circular shape detected in the image plane may be considered to represent a nucleus in case its difference in brightness in comparison to its (immediate) surroundings exceeds a predefined threshold. In a variation of this example, a circular or substantially circular shape in the image plane that exhibits sufficient difference in brightness to its (immediate) surroundings (i.e. difference that exceeds the predefined threshold) may be considered to represent a nucleus only in case a circular shape of darker appearance representing the nucleolus is detected at or close to the center of the circular or substantially circular shape. While various techniques are applicable in nucleus detection, a detailed example in this regard is outlined in the numbered clause 4 of the Appendix of this description.

As described in the foregoing, the positions of the image plane that indicate respective nuclei positions are referred to as second image plane positions, denoted as p₂(l), with l=1, . . . , L where L is an integer with L>1. In a preferred example, the second image plane position p₂(l) that represents a given nucleus indicates image plane position of the center or approximate center of the given nucleus.

Referring to block 160 of the method 100, the operations associated therewith may be carried out by the cell division means 260. Hence, the operations described herein as exemplifying characteristics of the cell division means 260 are equally applicable as method steps associated with block 160 of the method 100.

The cell division means 260 is provided for dividing the image plane representation of the derived human CM, on basis of the detected positions of one or more elements of the derived human CM, into one or more areas that represent respective positions of one or more sarcomeres of the derived human CM, where the detected positions that serve as basis for the cell division may include the first positions p₁(k) and the second positions p₂(l) described in the foregoing. In an example illustrated in FIG. 5b, the cell division means 260 comprises the first direction detection means 270 and the second direction detection means 280 outlined in the foregoing. In this regard, the exemplifying operations associated with the first direction detection means 270 described in the following are equally applicable as method steps associated with the block 170 of the method 100, whereas the exemplifying operations associated with the second direction detection means 280 described in the following are equally applicable as method steps associated with the block 180 of the method 100.

The first direction detection means 270 may be arranged to define one or more first connecting lines, where each first connecting line connects an image plane position of a detected adhesion point to an image plane position of a detected nucleus. Herein, we denote the first connecting lines by v₁(m), with m=1, . . . , M, where M is an integer with M>0. In other words, using the notation applied in the foregoing, each first line v₁(m) connects one of the first positions p₁(k) to one of the second positions p₂(l). In this regard, each of the first positions p₁(k) is connected by a respective first connecting line v₁(m) to exactly one second position p₂(l). This implies that the number of first connecting lines M equals the number of first positions K. On the other hand, a second position p₂(l) may serve as an end point to zero or more first connecting lines v₁(k)., i.e. zero or more first positions p₁(k) may be connected by the respective first connecting lines v₁(k) to a single second position p₂(l).

According to an example, each first position p₁(k) is connected by a respective first connecting line v₁(k) to the second position p₂(l) that minimizes a distance measure that is descriptive of the distance between the respective first position p₁(k) and any of the second positions p₂(l). In an example, the distance measure comprises a Euclidean distance between the two positions p₁(k) and p₂(l), thereby resulting in connecting each first position p₁(k) to the second position p₂(l) that is closest thereto.

In another example, the distance measure comprises a weighted distance measure that emphasizes those nuclei that are close to the center of the depicted derived human CM. Herein, the center may comprise e.g. the center of mass computed on basis of the image plane positions that are enclosed by the cell outline. Within the framework of this example, the first direction detection means 270 may compute a radius of influence rᵢ(l) for each detected nuclei such that the closer the nuclei is to a center of the depicted human CM, the larger is the radius of influence rᵢ(l). In this regard, the first direction detection means 270 (or another component of the analyzer 200) may compute or estimate the center point p_{c} that represents the center of the depicted derived human CM e.g. on basis of the set Sₒₗ of points that define the cell outline, compute, for each detected nucleus, the distance between the nucleus (e.g. the respective second position p₂(l)) and the center point p_{c}, and derive the respective radius of influence rᵢ(l) on basis of the computed distance. Consequently the weighted distance measure describes the distance between a first position p₁(k) and a second position p₂(l) as the distance between the first position p₁(k) and a circle of radius rᵢ(n) centered at the second position p₂(l). There are many ways to provide a suitable weighting, e.g. one outlined in the numbered clause 5 of the Appendix of this description.

The second direction detection means 280 may be arranged to define one or more second connecting lines, where each of the second connecting lines connects an image plane position of a detected nucleus to an image plane position of another detected nucleus. Herein, we denote the second connecting lines by v₂(n), with n=1, . . . , n, where N is an integer with N≥0. In other words, using the notation applied in the foregoing, each second line v₂(m) connects one of the second positions p₂(l) to one of the other second positions p₂(l). In an example, assuming there are at least two second positions p₂(l) (i.e. at least two nuclei detected in the acquired image), each of the second positions p₂(l₁) is connected by a respective second connecting line v₂(n) to at least one other second position p₂(l₂). On the other hand, there is only a single second line v₂(n) connecting a given pair of second positions p₂(l₁) and p₂(l₂). A given second position p₂(l) may serve as an end point to one more second connecting lines v₂(k), i.e. one or more other second positions p₂(l) may be connected by the respective second connecting lines v₂(n) to the given second position p₂(l). It should be noted that in case there is only one detected nucleus and hence only one second position p₂(l), no second connecting lines v₂(n) will be defined.

According to an example, assuming at least two second positions p₂(l), each second position p₂(l₁) is connected by a respective second connecting line v₂(n) at least to the other second positions p₂(l₂) that minimizes a distance measure that is descriptive of the distance between the respective second positions p₂(l₁) and p₂(l₂). Along the lines described in the foregoing for the first connecting lines v₁(m), the distance measure may comprise Euclidean distance, which results in connecting each second position p₂(l₁) to the closest one of the other second positions p₂(l₂). Further along the lines described in the foregoing for the first connecting lines v₁(m), in another example the distance measure involves computing the radius influence rᵢ(l) for each detected nucleus and consider the distance between the respective circles of radii rᵢ(l₁) and rᵢ(l₂) centered around the second positions p₂(l₁) and p₂(l₂) as the distance between these second positions.

In an example, a given second position p₂(l₁) is connected exactly to one other second position p₂(l₂). In another example, the given second position p₂(l₁) is connected to a predefined number of other nuclei p₂(l₂), where the predefined number is larger than one, provided that other conditions are met (e.g. the requirement that only a single second connecting line v₂(n) connects a given pair of second positions p₂(l₁) and p₂(l₂) and/or a requirement set by any supplementary direction definition rule described in the foregoing).

The first connecting lines v₁(m) and the second connecting lines v₂(n), if any, serve to divide the derived human CM depicted in the acquired image into a plurality of segments that represent sarcomeres of the depicted human CM.

According to an example, the cell division means 260 is arranged to first employ the first direction detection means 270 to define the one or more first connecting lines v₁(m) and, subsequently, employ the second direction detection means 280 to define the one or more second connecting lines v₂(n). In another example, the cell division means 260 is arranged to first employ the second direction detection means 280 to define the one or more second connecting lines v₂(n) and, subsequently, employ the first direction detection means 270 to define the one or more first connecting lines v₁(n). The order in which the first and second connecting lines v₁(m) and v₂(n) are defined may play a role in a scenario where one or more predefined constrains for defining the first and/or second connecting lines v₁(m) and v₂(n) are applied. Examples of such constrains are described in the following.

The cell division means 260 may be further arranged to apply one or more constraints to defining the one or more first connecting lines v₁(m) and/or the one or more second connecting lines v₂(n). Such constraints may also be referred to as supplementary direction definition rules. A few non-limiting examples are described in the following:
According to a first exemplifying supplementary direction definition rule, the cell division means 260 refrains from defining any connecting lines that would cross one of the existing connecting lines v₁(m) or v₂(n) in the image plane.
According to a second exemplifying supplementary direction definition rule, the cell division means 260 refrains from defining any connecting lines that would result in a segment that has an area smaller than a predefined threshold.

Both of the exemplifying supplementary direction definition rules serve to introduce respective limitations into the division process in order to avoid dividing the image plane area that represents the derived human CM into unnecessary small segments that would not adequately model the sarcomeres of the derived human CM depicted in the acquired image.

The cell division means 260 may be further arranged to apply adhesion point clustering, i.e. clustering of the first positions p₁(k), in case predefined conditions in this regard are met. The adhesion point clustering contributes towards avoiding division of the image plane area that represents the derived human CM into unnecessary small segments that would not adequately model the sarcomere structure of the depicted derived human CM.

The adhesion point clustering is applied after having operated the cell division means 260 to define the first connecting lines v₁(m). According to an example, the adhesion point clustering may operate to combine two or more adhesion points into an aggregate adhesion point in a scenario where the respective two first positions p₁(k₁) and p₁(k₂) are connected by the respective first connecting lines v₁(m₁) and v₁(m₂) to the same second position p₂(lₐ) (i.e. to the same nucleus) and where the distance between the first positions p₁(k₁) and p₁(k₂) is shorter than a predefined threshold. In case this clustering condition for combining the two adhesion points is met, an aggregate adhesion point is defined as the point of the cell outline that is the midpoint between the first positions p₁(k₁) and p₁(k₂). The aggregate adhesion point replaces the first positions p₁(k₁) and p₁(k₂), and the first connecting lines v₁(m₁) and v₁(m₂) are replaced with a new first connecting line that connects the second position p₂(lₐ) to the aggregate adhesion point. This procedure for adhesion point clustering is repeated in an iterative manner until no further combinations of first positions and a second position that fulfill the above clustering condition are encountered.

The analyzer 200 may comprise the cell analysis means 290 that is arranged to carry out a further analysis of the derived human CM on basis of its division into said one or more areas by the cell division means 260. As described in the foregoing, non-limiting examples concerning operation of the cell analysis means 290 include maturity level estimation of the derived human CM depicted in the acquired image and motion estimation within one or more sarcomeres of the derived human CM in accordance with positions of the respective sarcomeres e.g. in a video stream depicting the same derived human CM in the same position of the image plane as in the acquired image used as basis for determination of the biomechanical structure.

In an example where the cell analysis means 290 comprises the motion estimation means, the motion analysis may be carried out in selected one or more sarcomeres of the derived human CM by analyzing respective image areas of the video stream that depicts the same derived human CM in the same position of the image plane as in the acquired image used as basis for determination of the biomechanical structure, where the motion analysis may be conducted using any motion estimation technique known in the art.

In an example where the cell analysis means 290 comprises the maturity level estimation means, the maturity level estimation of the derived human CM depicted in the acquired image may be carried out on basis of segmentation into said one or more areas that represent the sarcomeres of the depicted derived human CM. In this regard, the maturity level estimation may be based directly on the areas resulting from the cell division procedure described in the foregoing, on the first connecting lines v₁(m) and/or the second connecting lines v₂(n), or on both the areas resulting from the segmentation procedure and the first connecting lines v₁(m) and/or the second connecting lines v₂(n). As a particular example, the maturity level estimation may be based in directionality of the areas and/or connecting lines v₁(m) and/or v₂(n).

Typically, in a relatively mature derived human CM the first and second connecting lines v₁(m), v₂(n) tend to appear as one or more relatively long lines that follow or approximate longitudinal axis of the depicted derived human CM together with one or more relatively short first and second connecting lines v₁(m), v₂(n) that are substantially randomly aligned with respect to the longitudinal axis of the depicted derived human CM. In contrast, typically, in a relatively immature derived human CM the first and second connecting lines v₁(m), v₂(n) tend to appear as one or more lines of similar or approximately similar length that are substantially randomly aligned with respect to the longitudinal axis of the depicted derived human CM.

According to an example, the maturity level estimation may be carried out on basis of extent of alignment between the connecting lines v₁(m) and v₂(n) and a reference axis. Note that the extent of alignment may be based on first connecting lines v₁(m) only in as a scenario where no second connecting lines v₂(n) have been defined (i.e. in case less than two nuclei have been detected in the depicted derived human CM). Herein, the reference axis represents or approximates the longitudinal axis of the depicted derived human CM. In this regard, techniques know in the art may be applied in determining the reference axis as the longitudinal axis of the depicted derived human CM e.g. on basis of the set Sₒₗ that includes the image plane positions that represent the cell outline. In case no reference axis can be determined on basis of the cell outlined defined by the image plane positions in the set Sₒₗ, a randomly selected axis may serve as the reference axis.

The extent of alignment may be estimated by using any suitable technique known in the art. As an example in this regard, e.g. the following procedure may be employed:
Determining, for each defined first and second connecting line v₁(m), v₂(n), an angle between the respective connecting line v₁(m), v₂(n) and the reference axis;
Determining a weighted average of the angles, were each determined angle is weighted by a weighting factor that is a defined by a ratio of the length of the respective connecting line v₁(m), v₂(n) divided by the sum of lengths of all connecting lines v₁(m), v₂(n);
Using the weighted average of the angles as an indication of the extent of alignment and hence as an estimate of the maturity level of the depicted derived human CM. Herein, a relatively small value for the weighted average of the angles serves as an indication of strong alignment between the connecting lines v₁(m), v₂(n) and hence as an indication of relatively mature derived human CM, whereas a relatively high value for the weighted average of the angles serves as an indication of weak alignment between the connecting lines v₁(m), v₂(n) and hence as an indication of relatively immature derived human CM.

Instead or in addition to the cell analysis means 290, the analyzer 200 may comprise cell structure visualization means that is arranged to compose an image that depicts at least some of the information obtained via operation of the cell element detection means 230 and/or the cell division means 260. In particular, the cell structure visualization means may compose a cell division image where at least the first connecting lines v₁(m) and the second connecting lines v₂(n) and possibly also one or both of the first positions p₁(k) and the second positions p₂(l) are overlaid on the acquired image (or the pre-processed image). The cell structure visualization means may further provide cell division image for display via a display means (e.g. an electronic display coupled to the analyzer 200) and/or store the cell division image for further viewing in a storage means (e.g. a memory or a mass storage device coupled to the analyzer 200). FIG. 6 schematically illustrates an example of a cell division image where six first connecting lines connect respective adhesion points to one of the three nuclei and two second connecting lines connect the nuclei to each other. The example of FIG. 6 depicts a relatively mature derived human CM where the sarcomeres are predominantly aligned or substantially aligned with longitudinal axis of the derived human CM.

In the foregoing, the estimation of biomechanical structure of the derived human CM has been described with explicit or implicit references to a single derived human CM. This, however, is a non-limiting example and the estimation technique described in the foregoing readily generalizes into biomechanical structure estimation of a cell aggregate that comprises a plurality of derived human CMs. In this exemplifying variant of the method 100 and/or analyzer 200, the following clarifying remarks with respect to an application of the method 100 and/or the analyzer 200 are provided:
The operations of the image acquisition means 210 (possibly including the image pre-processing means 220) are basically unaffected in a scenario where the cell aggregate (of a plurality of derived human CMs) is processed instead of a single derived human CM.
The operations of the cell element detection means 230 serve to detect image plane positions of cell elements of interest in the plurality of derived human CMs of the cell aggregate. As an example, the cell element detection means 230 may operate to detect the cell outline of the cell aggregate instead of the cell outline of a single derived human CM, to detect the adhesion points (i.e. the first positions p₁(k)) in the outline of the cell aggregate and detect the nuclei in the plurality of derived human CMs of the cell aggregate.
The operations of the cell division means 260 serve to define the first and second connecting lines v₁(m) and v₂(n) that may cross borders of individual derived human CMs of the cell aggregate.
The cell analysis means 290 serves to jointly carry out carrying out the further analysis of the plurality of derived human CMs of the cell aggregate.

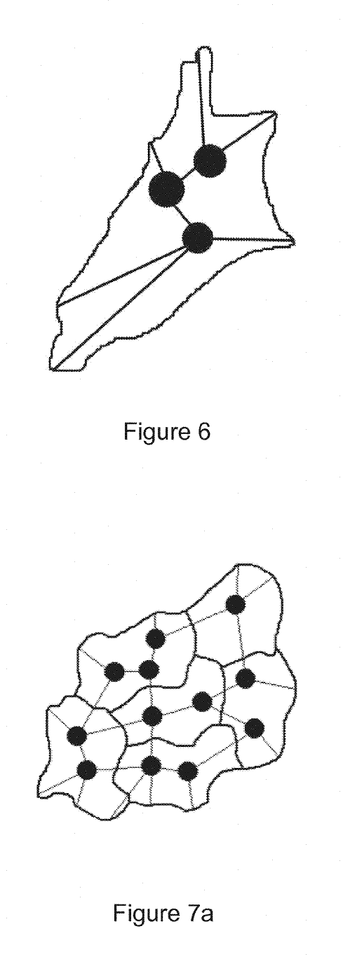

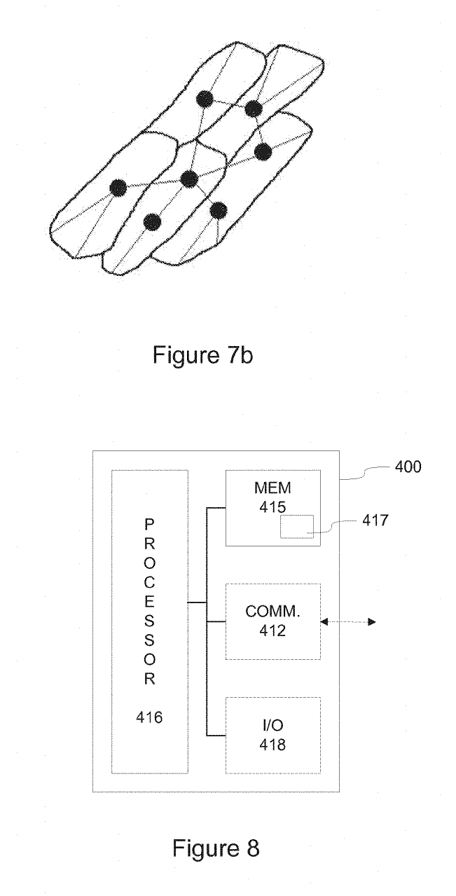

FIGS. 7a and 7b schematically illustrate respective examples of resulting cell division image after carrying out the analysis according to the method 100 and/or by using the analyzer 200 for a cell aggregate. FIG. 7a depicts a cell aggregate of seven relatively immature derived human CMs, where the first and second connecting lines fail to divide the cell aggregate into areas that are aligned or substantially aligned with a longitudinal axis of the cell aggregate, whereas FIG. 7b depicts a cell aggregate of five relatively mature derived human CMs, where the first and second connecting lines divide the cell aggregate into areas that are substantially aligned with the longitudinal axis of the cell aggregate.

In the foregoing, the biomechanical structure estimation has been described with explicit or implicit references to carrying out the various analysis steps on basis of a single acquired image (or pre-processed image). This, however, is a non-limiting example and the technique described in the foregoing readily generalizes into analysis that is based on visual data of other type, for example on a sequence of images (e.g. a video sequence) depicting the derived human CM (or the cell aggregate). In this exemplifying variant of the method 100 and/or analyzer 200, the following clarifying remarks with respect to an application of the biomechanical structure estimation using the method 100 and/or the analyzer 200 are provided:
The operations of the image acquisition means 210, possibly including the image pre-processing means 220, serve to obtain and/or process the sequence of images instead of a single still image.
The operations of the cell element detection means 230 serve to detect image plane positions of cell elements of interest in the sequence of images instead of relying on a single image only. In this regard, depending on the element under consideration, the detection may require that the respective element is detected in a plurality of images of the sequence, e.g. in at least a predefined number of images or in at least a predefined percentage of images.
The operations of the cell division means 260 are basically unaffected in a scenario where the analysis relies on a sequence images instead of a single image only.

The components of the analyzer 200 may be provided by hardware means, by software means, or by a combination of hardware means and software means. In the following, non-limiting examples of providing the analyzer 200 are provided. In this regard, FIG. 8 illustrates a block diagram of some components of an exemplifying apparatus 400. The apparatus 400 may comprise further components, elements or portions that are not depicted in FIG. 8. The apparatus 400 may be employed in implementing the analyzer 200.

The apparatus 400 comprises a processor 416 and a memory 415 for storing data and computer program code 417. The memory 415 and a portion of the computer program code 417 stored therein may be further arranged to, with the processor 416, to implement the function(s) described in the foregoing in context of components of the analyzer 200.

The apparatus 400 may comprise a communication portion 412 for communication with other devices. The communication portion 412, if present, comprises at least one communication apparatus that enables wired or wireless communication with other apparatuses. A communication apparatus of the communication portion 412 may also be referred to as a respective communication means. The apparatus 400 may further comprise user I/O (input/output) components 418 that may be arranged, possibly together with the processor 416 and a portion of the computer program code 417, to provide a user interface for receiving input from a user of the apparatus 400 and/or providing output to the user of the apparatus 400 to control at least some aspects of operation of the analyzer 200 implemented by the apparatus 400. The user I/O components 418 may comprise hardware components such as a display, a touchscreen, a touchpad, a mouse, a keyboard, and/or an arrangement of one or more keys or buttons, etc. The user I/O components 418 may be also referred to as peripherals. The processor 416 may be arranged to control operation of the apparatus 400 e.g. in accordance with a portion of the computer program code 417 and possibly further in accordance with the user input received via the user I/O components 418 and/or in accordance with information received via the communication portion 412.

Although the processor 416 is depicted as a single component, it may be implemented as one or more separate processing components. Similarly, although the memory 415 is depicted as a single component, it may be implemented as one or more separate components, some or all of which may be integrated/removable and/or may provide permanent/semi-permanent/dynamic/cached storage.

The computer program code 417 stored in the memory 415, may comprise computer-executable instructions that control one or more aspects of operation of the apparatus 400 when loaded into the processor 416. As an example, the computer-executable instructions may be provided as one or more sequences of one or more instructions. The processor 416 is able to load and execute the computer program code 417 by reading the one or more sequences of one or more instructions included therein from the memory 415. The one or more sequences of one or more instructions may be configured to, when executed by the processor 416, cause the apparatus 400 to carry out operations, procedures and/or functions described in the foregoing in context of the analyzer 200.

Hence, the apparatus 400 may comprise at least one processor 416 and at least one memory 415 including the computer program code 417 for one or more programs, the at least one memory 415 and the computer program code 417 configured to, with the at least one processor 416, cause the apparatus 400 to perform operations, procedures and/or functions described in the foregoing in context of the analyzer 200.

The computer programs stored in the memory 415 may be provided e.g. as a respective computer program product comprising at least one computer-readable non-transitory medium having the computer program code 417 stored thereon, the computer program code, when executed by the apparatus 400, causes the apparatus 400 at least to perform operations, procedures and/or functions described in the foregoing in context of the analyzer 200. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

### APPENDIX: IMPLEMENTATION EXAMPLES

The following numbered clauses describe non-limiting examples for providing some of the operations described in context of the image pre-processing means 220, the cell element detection means 230 and the cell division means 260.

1. Image Segmentation

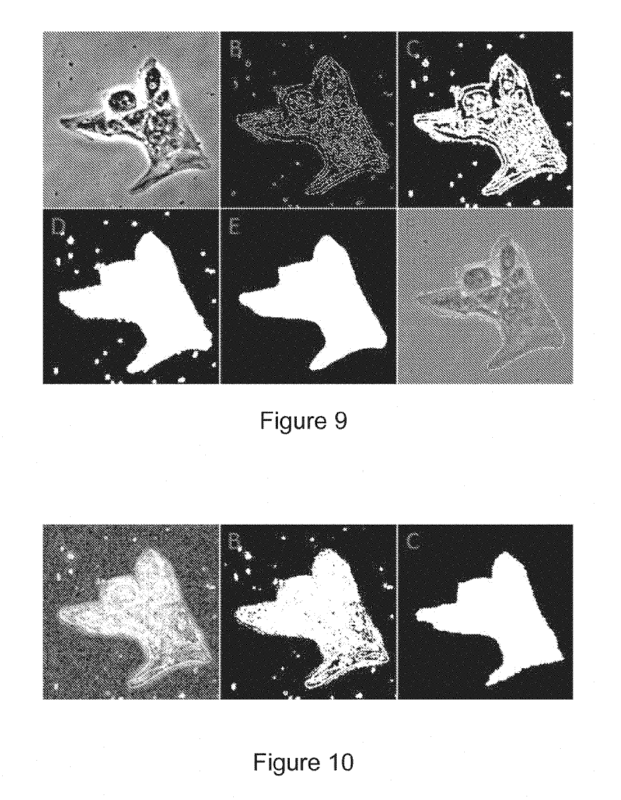

An exemplifying image segmentation procedure is described in the following and the main phases of it are illustrated in FIG. 9. First, the image contrast is increased by stretching the image histogram using the imadjust-function in Matlab (Virhe. Viitteen ländettä ei löytynyt. A).

From the resulting contrast enhanced image, the gradients are calculated, in order to reveal places where the intensity changes rapidly or in other words, to find the edges. This is done using the edge-function in Matlab and using the Canny method, which looks for strong and weak edges separately and then includes the weak edges in the output only if they are connected with a strong edge (FIG. 9B).

Next, the gradient image is dilated in order to close the contour lines of the cells as much as possible but at the same time trying to keep separate objects in the image from connecting to each other using the imdilate-function in Matlab. The closed areas formed this way are then filled using the imfill-function in Matlab (FIG. 9 C-D).

After this, the remaining non-cell objects are removed based on the pixel size of the objects. 6000 pixels has been experimentally determined to be a suitable threshold, since most of the non-cell objects are clearly smaller than this and at the same time the smallest actual cells are clearly larger than this. Now, when the risk of connecting cell objects to non-cell objects is minimized, the dilation and filling operations are repeated trying to capture cell regions that were possibly not captured in the first dilation round. After this, some eroding operations are performed to restore the increased size of the segmentation back to normal.

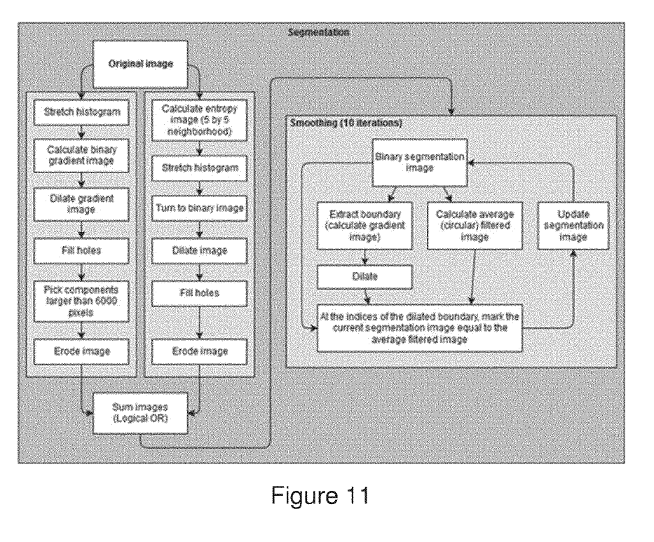

At this point, the segmentation is otherwise ready but its contour may still be quite rough after the eroding operations. Therefore, to finalize the segmentation, the contour may be smoothed. For this, an iterative smoothing procedure that works basically by performing circular average filtering only to the boundary area of the segmentation has been developed. The procedure is referred to in the foregoing with references to FIG. 11.

In most cases, the procedure described in the preceding provides satisfying segmentation of the cell. However, in some cases, also small background objects near the border of the cell connect to the segmentation at some point of the procedure producing unwanted chunks at the edge of the final segmentation. Also, in some cases, the contour of the cell may be partly lost in the segmentation procedure, or it may not be recognized properly in the first place due to the too weak contrast between the cell and the background in the original image. In these cases only fraction of the cell is captured in the segmentation. For this problem, a fix has been developed utilizing the entropy of the different textures. The basic idea in the fix is to make another parallel segmentation but with different technique, and then logically sum the segmentations together to produce the final segmentation. The main phases of the alternative segmentation are illustrated FIG. 10. The extra segmentation is made by calculating the entropy of the 5×5 neighborhood for each pixel in the original image (FIG. 10 A). The resulting grayscale entropy image is then transformed to binary image for which some dilation operations are performed, followed by filling, and eroding operations, to produce the alternative segmentation (FIG. 10 B-C).

The two segmentations may be combined as a logical OR-operation. The resulting segmentation is then smoothed as described in the foregoing to produce the final result. Experimental results indicate that in some cases the alternative segmentation alone may have the same weakness of not capturing the whole cell to the segmentation. However, these areas were not the same as the ones that the original procedure could not capture. Therefore, by combining the two segmentations, the problem could be overcome for the most part.

A further example regarding the image segmentation is illustrated by a block diagram depicted in FIG. 11. This example makes use at least some parts of the segmentation procedures outlined in the foregoing. In a smoothing procedure of the block diagram of FIG. 11, the current segmentation image is taken, and two different images are calculated from it; a gradient image, and an average filtered image. The gradient image, which represents the boundary of the current segmentation, is dilated. Now, the dilated boundary is used as indices, to set the current segmentation image equal to the average filtered image at these indices. This produces the segmentation image for the next iteration. For example ten iterations may be applied to produce a sufficiently smooth boundary for the segmentation.

2. Regarding Adhesion Points of a Derived Human CM

Tension of a cell controls formation of adhesive structures of the cell, such as intercalated discs and focal adhesion complexes. Also, in the case of cultured CMs, the intercalated disc structures can be formed around the perimeter of the cell wherever extracellular adhesion is present, given that no specific adhesive cues are provided. Therefore, by visually examining cultured CMs, the locations of adhesion points can be estimated, by estimating the locations in which the tension is at its highest. These locations in turn can be assumed to be at the steepest points of cell perimeter, or in other words, at the steepest corner points. Therefore, it can be concluded that the intercalated disc structures including the adherens junctions are also concentrated on the corner points. Further on, this would mean that the myofibrils are mainly anchored in these points via the terminal actin filaments.

The nuclei of the cell are connected to the myofibrils via the intermediate desmin filaments. Therefore, if a position of a nucleus is known, it can be concluded that some of the myofibrils are “travelling” past the point in question.

This is relevant e.g. in the case of phase contrast microscopy images because in these type of images the structure and orientation of the myofibrils cannot be seen properly, but the nuclei can, to some extent at least. Also, in the case of hiPSC-derived CMs, the shape of the cells can be vaguely polygonal as oppose to the elongated shape seen in well matured cells, meaning that the myofibril structure cannot easily be concluded based on the mere shape of the cell. In these cases, a nucleus can work as an indicator of an underlying myofibril, and can be seen almost as a node between differing myofibril orientations.

Based on the preceding considerations, the structure and orientation of the myofibrils can be estimated also based on the phase contrast microscopy images, because the locations of the corner points as well as the nuclei can be observed in the cells. This gives the basis to build a wireframe model that serves to estimate the biomechanical structure of the cell.

3. Regarding Corner Point Detection

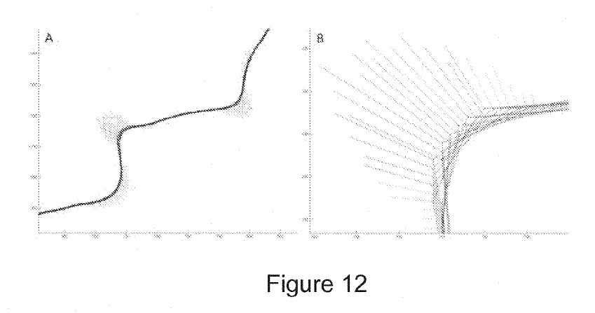

For detection of corner points of a cultured CM, e.g. an open-source Matlab-function (Kroon DJ, 2D Line Curvature and Normals) that is available online at the filing date of the present patent application at http://www.mathworks.com/matlab/central/fileexchange/32696-2d-line-curvature-and-normals may be applied for estimating the curvature of a given set of coordinates. This function works in a way that it calculates the normals for the given set of points based on the two neighboring points, the length of the normal indicating how large an angle is formed between the points. Therefore, these normals can then be used in estimating the curvature of the cell boundary and thus determining, where the corner points are located. For this, the boundary coordinates of the cell segmentation are traced. The tracing may be done in counter-clockwise order detecting always the next 4-connected neighbor coordinate in the direction. However, as a result of this kind of tracing, the neighboring coordinates form only either 0 or 90 degree angles. Therefore, if all the coordinates are used by the function at once, normals of large length are plotted basically everywhere, giving really no useful information about the larger-scale corner point locations. To overcome this, the boundary coordinates may be divided into subsets to be used with the normal-calculating function. That is to say, the normals are first calculated for a coordinate set including every 14th coordinate of the original set, starting from the first coordinate. Then, another subset is constructed with the same logic but starting from the second coordinate of the original set, then starting from the third etc. until finally starting from the 13th coordinate. As a result, a single normal with a specific length is calculated for all the boundary coordinates. This is visualized in FIG. 12.

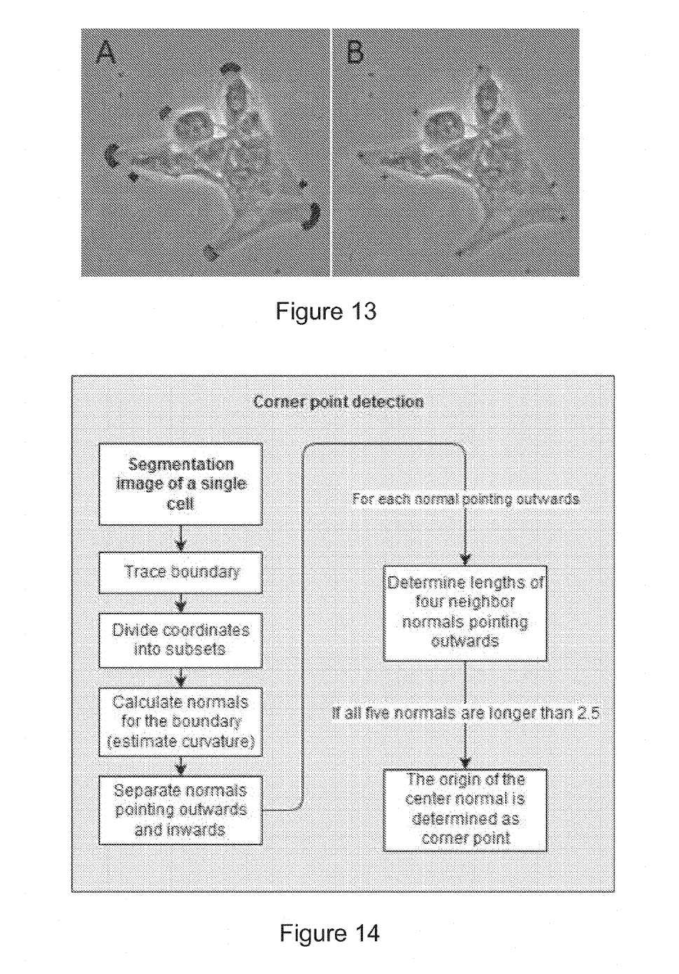

To determine the locations of the cell corner points out of the normal data, a threshold for normal length is set, meaning that only boundary points with normal length more than the threshold are considered as corner points. Examples in this regard are illustrated by dark bold curves outside the cell perimeter in FIG. 13A and as dark ‘plus signs’ (or ‘stars’) at the cell perimeter in FIG. 13B. This evaluation is naturally made separately for normals pointing outwards and normals pointing inwards, in order to not mix the outside corners of the cell with inside ones. With this kind of logic, not a single coordinate but usually a cluster of adjacent boundary coordinates is obtained, indicating the position of a single corner of a cell. An example of this can be seen in FIG. 13A. To represent a single corner point of the cell with a single coordinate, the middle point of each separable cluster is selected, as can be seen in FIG. 13B. It should be noted that in FIG. 13 only outside corners are visualized.

Another approach for corner point detection involves assigning a probability for the detected corner points based on the mean length of the neighboring normals. In other words the probability would have indicated the strength of the corner point, which is illustrated in FIG. 12A.

FIG. 14 illustrates a further example concerning the corner point detection, which is in part based on the normal-calculating approach described in the foregoing. In this regard, as mentioned in the foregoing, the boundary of the segmentation is formed from either 0 or 90 degree angles. Therefore, the boundary is divided into subsets to be able to detect the curvature in larger scale. The experimentally determined number 14 as the number of subsets has turned out to be suitable for detecting curvature representing cell corners, meaning that the procedure is not sensitive to very small scale or very large scale curvature. Further, in some cases there may be roughness left in the segmentation causing single normals above the threshold length to be calculated in places where there is no actual corner point present. To prevent these separate normals from being detected as corner points, it may be defined that if normals at five adjacent boundary coordinates are all longer than the threshold (set e.g. to an experimentally determined value 2.5), then the middle point is classified as a corner point of the cell.

4. Regarding Nucleus Detection

Visually, the nuclei of the cells can be seen in the images as circles, roughly speaking. In most cases, the circles appear slightly brighter than the surroundings but in few cases this is just the opposite. Also, usually roughly at the center of the nucleus, there can be seen the nucleolus as a small dark circle, that is to say, darker than the nucleus otherwise.

According to an example, a basic idea in detecting a nucleus of a cultured CM is to look for bright circles, dark circles and the small dark circles each from different images, in a way that the preprocessing made for each image is optimal for finding the corresponding type of circle. The goal is also to utilize the appearance of the nucleoli as small dark circles, in a way that if a small dark circle is found inside a larger circle, the larger one is classified as a nucleus with a stronger certainty. The preprocessing included histogram equalization, intensity remapping, and moving average filtering. When the imfindcircles-function (referred to in the foregoing) is now used on the preprocessed images to find the nuclei, the recognition rate increases in comparison to known methods in that both the false positive- and false negative rates are decreased. Some details of an exemplifying procedure according to these principles is descried in the foregoing.

After calculating all the circles from the differently processed images, deciding which ones of the circles were actually a nucleus and which ones not, is made by pruning some of the circles away if necessary. To do this, several conditions are applied for false circles, and if the any of the conditions is met in the case of any of the circles, the circle in question is removed from the final set of detected nuclei. Examples of such conditions are described in more detail in the foregoing.

It has been noticed that the imfindcircles-function is sensitive even to very small variations between different image frames (of a video sequence), also given that the cell is at rest. That is to say, the result given by the function may be different between consecutive image frames (of a video sequence) even if there is no notable difference based on visual inspection. Therefore, a number of consecutive frames may be used in finding the nuclei in a way that a single nucleus had to be found in multiple frames in order to accept the result. This is described in more detail in the foregoing.

In a pre-processing phase, the contrast of the original image is enhanced using contrast limited adaptive histogram equalization (adapthisteq in Matlab). For the resulting image, an open source digital filtering function may be used to perform a moving average filtering (e.g. Aguilera CAV, ndnanfilter.m, which is available at the filing date of the present patent application at http://www.mathworks.com/matlab/central/fileexchange/20417-ndnanfilter-m). Then, a difference image is calculated by subtracting the average filtered image from the contrast enhanced image. This way the larger scale variability in the luminance can be minimized in the resulting difference image. The same image may not be suitable for finding the nuclei seen as dark circles as well. However, finding the nucleoli seen as dark small circles has turned out to be more efficient when remapping the intensity values of the original image in a way that darker intensities are mapped to cover the whole intensity range. Specifically, two different images are made this way from the original image; one, where intensities 30-120 are scaled to cover the whole intensity range 0-255, and another one where intensities 30-160 are scaled similarly. The first remapped image is enough in most cases, but in the case of some images, the result image is too bright, almost fully saturated. The second remapped image and the difference image described earlier, serve as backup in these cases. Altogether, the small dark circles are searched from three separate, differently processed images. The input parameters of the imfindcircles-function for each circle type have been optimized by trial and error, and can be seen in the following table.

| | Circle type | | | |
|---|---|---|---|---|
| | Bright | Dark | small dark | small dark |
| | circles | circles | circles 1 | circles 2 |
| Radius range | 12-23 | 12-31 | 1-7 | 1-10 |
| (pixels) | | | | |
| Sensitivity | 0.85 | 0.83 | 0.46 | 0.4 |
| Method | ‘TwoStage' | ‘TwoStage' | ‘TwoStage' | ‘TwoStage' |

After finding all the circles, some of them are removed if specific conditions are met. This gives the final estimation of the nuclei. First, all the circles outside the segmentations of the cells are removed. Also, the detected bright circles are considered as first priority, meaning that if some of the detected dark circles are overlapping with the bright ones, these dark circles are removed. Thirdly, it has been noticed that on some cells, there can be seen small circular structures or excess objects that were not nuclei, but that are detected as such. Usually, these structures have bright spots on them, which makes it possible to separate them from nuclei. That is to say, circles inside which there is at least one pixel with intensity value of 255 are removed. After the preceding pruning operations, all the larger circles are the best estimate for the nuclei locations.

Also, it has been noticed that even very small differences in the consecutive frames of the video may cause variability in the identified circles. To overcome this, the preceding nuclei detection procedure may be done for ten consecutive frames of a video sequence: If the same nucleus is found in at least three frames out of ten the nucleus so identified is accepted. However, here the “same” does not mean “exactly the same” since the position and size of the circle representing the same nucleus may slightly vary between different image frames. Therefore it is defined that if the center points of single circles in two different image frames are in the range of 20 pixels, they are representing the same nucleus.

5. Regarding Definition of Connecting Lines

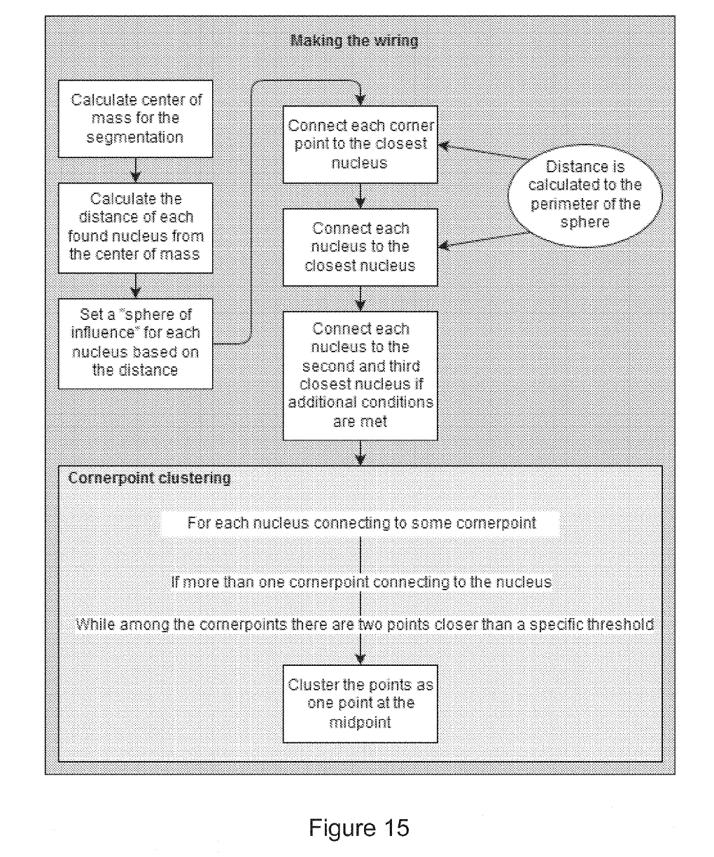

FIG. 15 illustrates a block diagram that provides an exemplifying procedure for creating the wireframe model (referred to in the foregoing) that serves to estimate the biomechanical structure of the cell and that includes the first and second connecting lines described in detail in the foregoing. The procedure outlined in the block diagram of FIG. 15 involves usage of a concept denoted as a ‘sphere of influence’. The sphere is used in calculating the distances between different points of the model in a way that the closer the nucleus is to the center of the cell, the larger is its sphere of influence. This adds importance to the nuclei close to the center of the cell, making other points connect to them more easily, since the distance is now calculated to the perimeter of the sphere. The sphere of influence is determined for each nucleus as follows. First, the maximum distance between the center of mass and a single nucleus is determined. Then a normalized normal distribution is created. The standard deviation of the distribution is set equal to the previously calculated maximum distance, divided by three. Then for each nucleus, the distance to the center of mass is calculated. Then, in the normal distribution, this distance is measured from the center along the x-axis and the y-value in this point is chosen. This value multiplied by the previously calculated maximum distance is now the radius of the sphere of influence for the nucleus in question.

1-15. (canceled)

16. A method for estimating a biomechanical structure of one or more derived human cardiomyocytes on basis of at least one image that represents the one or more derived human cardiomyocytes, the method comprising
detecting respective image positions of predefined elements of the one or more derived human cardiomyocytes, comprising
detecting one or more first positions that indicate respective one or more adhesion points of a cell outline of the one or more derived human cardiomyocytes where they attach to their substrate, and
detecting one or more second positions that indicate respective positions of one or more nuclei of the one or more derived human cardiomyocytes;
dividing the image representation of the one or more derived human cardiomyocytes into a plurality of areas that represent respective sarcomeres of the one or more derived human cardiomyocytes; and
carrying out a further analysis of the one or more derived human cardiomyocytes on basis of division of the image representation of the one or more derived human cardiomyocytes into said plurality of areas.

17. A method according to claim 16, comprising pre-processing the at least one image to emphasize visual appearance of at least said predefined elements of the one or more derived human cardiomyocytes in the at least one image.

18. A method according to claim 16, wherein detecting respective image positions of predefined elements further comprises
obtaining a set of image positions that indicate location of the cell outline and wherein detecting one or more first positions comprise
identifying one or more local maxima of curvature of the cell outline; and
determine at least one of the identified one or more local maxima as respective one or more first positions.

19. A method according to claim 16, wherein detecting respective image positions of predefined elements further comprises
obtaining a set of image positions that indicate location of the cell outline and wherein detecting one or more second positions comprise
detecting, within image area enclosed by the cell outline, one or more circular or substantially circular areas;
identifying center points of those circular or substantially circular areas where the difference in brightness within the area in comparison to its surroundings exceeds a predefined threshold as respective second positions.

20. A method according to claim 16, wherein dividing the image representation of the one or more derived human cardiomyocytes into a plurality of areas comprises
defining one or more first connecting lines, where each first connecting line connects a first position to one of the second positions; and
defining one or more second connecting lines, where each second connecting line connects a second position to another second position.

21. A method according to claim 20,
wherein defining one or more first connecting lines comprises connecting each first position to the second position that is closest to the respective first position according to a distance measure, and
wherein defining one or more second connecting lines comprises connecting each second position at least to the second position that is closest to the respective second position according to the distance measure.

22. A method according to claim 21, wherein the distance measure comprises
computing, for each second position, a distance between the respective second position and the center of mass of the one or more derived human cardiomyocytes;
deriving, for each second position, a respective radius of influence in dependence of the computed distance to the center of mass of the one or more derived human cardiomyocytes such that the radius of influence decreases with increasing distance to the center of mass;
defining a distance between a first position and a second position as distance between the first position and a circle having a radius of influence derived for the respective second position; and
defining a distance between two second positions as distance between circles having respective radii of influence derived for the two second position under consideration.

23. A method according to claim 20, wherein defining the one or more first connecting lines and the one or more second connecting lines comprises one or more of the following:
refrain from defining any first or second connecting lines that crosses one of the existing first or second connecting line;
refrain from defining any connecting line that would result in an area within the cell outline that is smaller than a predefined threshold.

24. A method according to claim 20, wherein dividing the image representation of the one or more derived human cardiomyocytes into a plurality of areas comprises
detecting two first positions connected by the respective two first connecting lines to a single second position;
determine an aggregate adhesion point as the midpoint of the cell outline between said two first positions; and
replace said two first connecting lines with a new first connecting line that connects the aggregate first position to said single second position.

25. A method according to claim 16, wherein carrying out a further analysis comprises estimating maturity level of the one or more derived human cardiomyocytes on basis of division of the image representation of the one or more derived human cardiomyocytes into said plurality of areas.

26. A method according to claim 25, wherein estimating the maturity level of the one or more derived human cardiomyocytes comprises estimating the extent of alignment between the first and second connecting lines with respect to a reference axis that represents or approximates longitudinal axis of the image representation of the one or more derived human cardiomyocytes.

27. A method according to claim 16, wherein the one or more derived human cardiomyocytes comprises one of the following:
a single dissociated derived human cardiomyocyte;
a cell aggregate comprising a plurality of derived human cardiomyocytes.

28. A method according to claim 16, wherein the at least one image comprises one of the following:
a single two-dimensional digital image;
a sequence of digital two-dimensional images that constitute a video sequence;
a single three-dimensional digital image;
a sequence of three-dimensional digital images that constitute a three-dimensional vide sequence.

29. An apparatus for estimating a biomechanical structure of one or more derived human cardiomyocytes on basis of at least one image that represents the one or more derived human cardiomyocytes, the apparatus comprising
a cell element detection means for detecting respective image positions of predefined elements of the one or more derived human cardiomyocytes, comprising
an adhesion point detection means for detecting one or more first positions that indicate respective one or more adhesion points of a cell outline of the one or more derived human cardiomyocytes where they attach to their substrate, and
a nucleus detection means for detecting one or more second positions that indicate respective positions of one or more nuclei of the one or more derived human cardiomyocytes;
a cell division means for dividing the image representation of the one or more derived human cardiomyocytes into a plurality of areas that represent respective sarcomeres of the one or more derived human cardiomyocytes; and
a cell analysis means for carrying out a further analysis of the one or more derived human cardiomyocytes on basis of division of the image representation of the one or more derived human cardiomyocytes into said plurality of areas.

30. A computer-readable non-transitory medium having computer readable program code stored thereon, which program code is configured to cause a computing apparatus to perform steps of the method of claim 16 when said program code is executed on the computing apparatus.
